(19) United States
(12) Patent Application Publication
(10) Pub. No.: US 2007/0086508 A1
(43) Pub. Date: Apr. 19, 2007

(54) Hand-held instrument for measuring temperature

(75) Inventors: Shannon Reading, Easton, PA (US); Joseph E. Fabin, Elmwood Park, IL (US)

Correspondence Address: Tait R. Swanson;FLETCHER YODER, P.O. Box 692289, Houston, TX, 77269-2289, US

(73) Assignee: Illinois Tool Works Inc.

(21) Appl. No.: 11/582,591

(22) Filed: Oct. 18, 2006

Related U.S. Application Data
(60) Provisional application No. 60/728,111, filed on Oct. 19, 2005.

(51) Int. Cl. G01K 7/00; G01K 1/00

(52) U.S. Cl. 374/208; 374/179

(57) ABSTRACT

A hand-held instrument, in certain embodiments, is configured to detect and indicate the surface temperature of an object. The hand-held instrument may include a temperature transducer, electronics, and a power source in a single hand-held chassis or housing. Additionally, the hand-held instrument may include a temperature indicator configured to output an indication of the temperature in real-time. The hand-held instrument may also include memory for storing data and communications circuitry for transmitting and receiving data to and from a remote unit or work station.

### REFERENCE TO RELATED APPLICATION

This application claims priority to U.S. Provisional Application No. 60/728,111, filed on Oct. 19, 2005.

### BACKGROUND

The present invention relates to a temperature sensor, and more particularly, to a hand-held instrument for measuring a surface temperature of an object.

Temperature sensors are used in a number of different industries and applications. Temperature sensors provide important feedback by determining and indicating the surface temperature of components that are included in various mechanical and electrical systems. Generic application examples include using a temperature sensor to determine the surface temperature of an electrical component contained within an electrical system, or using a temperature sensor to determine the surface temperature of an object exposed to either an internal or external heat source. One specific application of a temperature sensor can be found in the welding industry, where a temperature sensor may be used to indicate the surface temperature of an object during a pre-weld or post-weld heat treatment.

One method of determining the temperature of an object is via a consumable temperature indicator, sometimes referred to as a heat crayon. The general process for using these types of indicators includes marking the object with a dry opaque mark and then observing the phase change of the mark (i.e., the mark melts or smears) when the temperature rating for that particular compound is reached. Examples of these types of consumable temperature indicators are marketed under the trademark Tempilstik°—temperature indicating sticks, Tempilaq°—temperature indicating liquids, and Tempil° pellets by Tempil of South Plainfield, N.J. These temperature indicators are designed to operate at temperatures as low as 100 degrees Fahrenheit up to temperatures as high as 2500 degrees Fahrenheit. However, each compound is specially formulated for a specific temperature. As a result, a plurality of different temperature indicators are required to identify a plurality of different temperatures. Furthermore, these types of temperature indicators are consumable, and thus, have a finite number of applications before being fully consumed.

### BRIEF DESCRIPTION

Embodiments of the present invention enable a user to detect the surface temperature of an object in real-time. In certain embodiments, the present invention includes a temperature transducer, electronics, and a power source integrated into a single hand-held chassis or housing. Some embodiments of the housing may have a pen-shape, a gun-shape, or a disc-shape. In each of these embodiments, a preferred configuration includes an arcuate thermocouple element that is exposed and placed in direct contact with the object to be measured. The hand-held instrument may also include memory configured to store operating parameters and temperature data. Furthermore, the hand-held instrument may include wireless communications circuitry, such as a wireless transceiver, a wired communications port, or a combination thereof. The hand-held instrument may further include a temperature indicator, such as an audible indicator, a visual indicator, or a combination thereof.

### DRAWINGS

These and other features, aspects, and advantages of the present invention will become better understood when the following detailed description is read with reference to the accompanying drawings in which like characters represent like parts throughout the drawings, wherein:

FIG. 1 is an elevational view of a gun-shaped embodiment of a hand-held instrument for measuring the surface temperature of an object,

FIG. 2 is an elevational view of a pen-shaped embodiment of a hand-held instrument for measuring the surface temperature of an object;

FIG. 3 is an elevational view of a disc-shaped embodiment of a hand-held instrument for measuring the surface temperature of an object;

FIG. 4 is a perspective view of a remote unit configured to communicate with a hand-held instrument such as the embodiments illustrated in FIGS. 1-3;

FIG. 5 is a block diagram of a hand-held instrument for measuring surface temperature;

FIG. 6 is a diagram of a welding system illustrating one possible application of one or more of the hand-held instruments as illustrated in FIGS. 1-3;

FIG. 7 is a flow chart illustrating one method of using one of the embodiments as illustrated in FIGS. 1-5.

FIG. 8 is a flow chart illustrating a second method of using one of the embodiments as illustrated in FIGS. 1-5.

FIG. 9 is a flow chart illustrating a third method of using one of the embodiments as illustrated in FIGS. 1-5.

### DETAILED DESCRIPTION

As discussed in further detail below, various embodiments of a hand-held instrument are provided to measure the surface temperature of an object. The hand-held instrument is electronic, reusable rather than consumable, capable of measuring multiple temperatures rather than a single temperature, capable of communicating temperature data to a unit remotely located from the instrument, capable of enabling closed loop control of a system, and so forth. The disclosed embodiments include a variety of one-piece structures that house a temperature transducer and various electronics. In a preferred embodiment, the temperature transducer includes a thermocouple element that is exposed (i.e., not surrounded by a protective sheath or coating), such that the thermocouple element can be placed in direct contact with the object to be measured. The thermocouple element is also sufficiently thin to enable optimal heat transfer to the thermocouple element. Furthermore, the thermocouple element has an arcuate shape that is deformable to decrease the contact resistance between the target object and the thermocouple element. In other words, the arcuate shape functions like a spring, such that the thermocouple element itself is spring-loaded without any additional spring element. The foregoing features, among others, of the thermocouple element have the effect of minimizing resistive losses and increasing the response time of the instrument. As discussed below, embodiments of the hand-held instrument are able to measure temperatures up to 200, 300, 400, 500, 600, 700, 800, 900, 1000 degrees Fahrenheit or higher in real-time, which may generally be described as at least less than 2 seconds, less than 1 second, less than 0.5 second, or even lesser time.

The electronics may include a power source, signal processing circuitry, a time keeping chip, a controller, a temperature indicator, communications circuitry, memory, system control parameters disposed on the memory, or a combination thereof. The power source may include one or more batteries, capacitors, or a combination thereof. The signal processing circuitry may include an analog-to-digital converter, an amplifier, a filter, or a combination thereof. The temperature indicator may include a visual indicator, an audible indicator or alarm, a tactile or feel indicator (e.g., vibration), or a combination thereof. The communications circuitry may include wired and/or wireless circuitry, such as a wireless transceiver, a communications port, or a combination thereof. The memory may include volatile or non-volatile memory, such as read only memory (ROM), random access memory (RAM), magnetic storage memory, optical storage memory, or a combination thereof. Furthermore, a variety of control parameters may be stored in the memory along with code configured to provide specific output (e.g., alarm or information) to the user during operation, e.g., in response to a measured temperature of the system or component. As discussed below, certain embodiments of the hand-held instrument integrate some or all of these features into a one-piece housing, which can be readily used to provide real-time temperature information to the user.

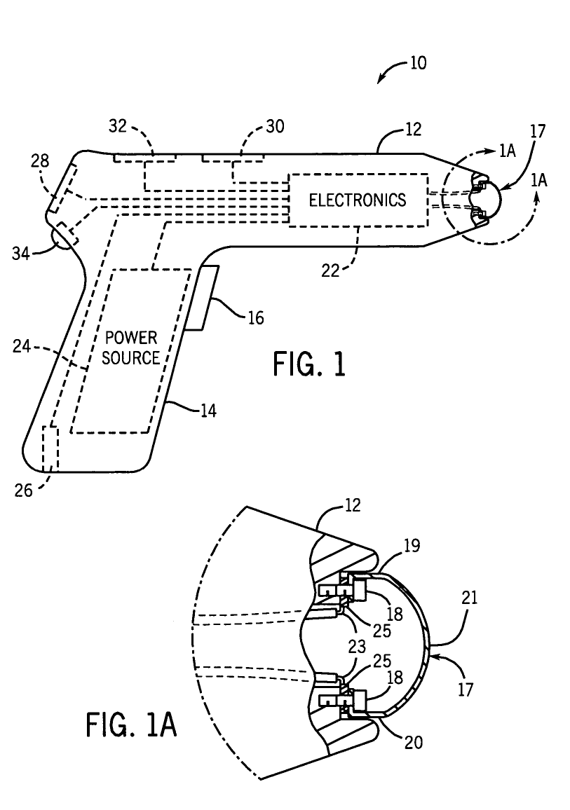

Turning now to the drawings, FIG. 1 illustrates exemplary elements of a hand-held instrument 10 in accordance with a first embodiment of the invention. In this embodiment, the hand-held instrument 10 comprises a gun-shaped chassis or housing. The housing comprises a barrel portion 12, a handle 14 for gripping the hand-held instrument, and a trigger 16 configured to start and stop data acquisition. Trigger 16 may be further configured with additional functions, such as enabling the user to indicate whether particular data should be permanently stored in memory. Additionally, the trigger could be configured in such a manner as to be activated by simply engaging the end of the barrel portion against the surface to be measured. For example, a proximity sensor, a push-button, or another trigger may be disposed at the end of the barrel portion. By further example, the trigger may be integrated with or coupled to a thermocouple element 17, such that contact of the thermocouple element 17 with the work surface automatically engages (i.e., turns on) the instrument 10. Finally, as will be illustrated by other embodiments, the hand-held instrument in not limited to this particular configuration, and may encompass any of the configurations shown, or additional configurations not illustrated that incorporate all of the elements into a single hand-held chassis.

The housing 10 includes a temperature transducer or thermocouple element 17 configured to detect and indicate a surface temperature of an object. In a preferred embodiment, thermocouple element 17 is exposed and configured to be placed in direct contact with the object to be measured. A preferred embodiment of thermocouple element 17 comprises an arcuate, spring-like member that may deflect and conform to the surface to be measured. This enables optimum force distribution between the thermocouple element 17 and the surface, thereby minimizing contact resistance (i.e., thermal resistive losses) between these elements leading to an increased heat flow to the thermocouple. Thermocouple element 17 is also sufficiently thin, between 0.003 inch and 0.020 inch thick, thereby reducing the thermal mass of element 17 and enabling a faster response time. Furthermore, this particular configuration enables the thermocouple element 17 to be thermally isolated from the housing 10. In other words, this configuration enables the placement of thermal barriers between housing 10 and thermocouple element 17, thereby reducing the heat sink effects of the relatively larger body housing 10. For example, in a preferred embodiment, the thermocouple element 17 may be the only element placed in contact with the surface to be measured. This configuration prevents thermal energy from flowing past the thermocouple element 17 and into the housing where it is diffused and undetectable, thus, having the affect of slowing or increasing the response time of the instrument. It is through minimizing the resistive components in the thermal circuit that a preferred embodiment enables the thermal energy to flow directly into the thermocouple element 17 where it may be detected and indicated. Additionally, the thermocouple element may include a thermal insulative backing, such as plastic, glass, or ceramic, to further minimize resistive losses and increase the time response of the instrument.

As discussed above, thermocouple element 17 is the temperature transducer or thermocouple, and is removably secured to the housing 10 via screws 18. This configuration enables the user to quickly replace thermocouple element 17 by removing screws 18. Thermocouple element 17 comprises a positive leg of the thermocouple 19 joined to a negative leg of the thermocouple 20 via a junction 21. Junction 21 is typically formed by butt welding the two legs of the thermocouple at this junction. Thermocouple element 17 is electrically coupled to electrical conductors 23 via contacts 25 and screws 18. Electrical conductors 23 are typically made from the same material as the respective positive 19 and negative 20 legs of the thermocouple element 17. Electrical conductors 23 are further coupled to electronics 22 and a power source 24 that are used to operate thermocouple element 17 in order to acquire a temperature measurement for an object. A power receptacle 26 may also be included for powering the device from an independent power source in lieu of, or in conjunction with, the power source 24 contained within the housing 10.

Thermocouple element 17 may include any of the commonly known type thermocouples (e.g., J, K, B, R, S, T, E, N, or G). A preferred embodiment of the present invention includes either a type-J or type-K thermocouple. The type-J thermocouples have an operating range from approximately 32 degrees Fahrenheit to approximately 1382 degrees Fahrenheit. The type-K thermocouples have an operating range from approximately −328 degrees Fahrenheit to approximately 2282 degrees Fahrenheit. An exemplary embodiment of thermocouple element 17 is manufactured by OMEGA Engineering, located in Stanford, Conn., and may be identified by model number 88003. However, other types of thermocouples or temperature transducers may be used in the hand-held instrument.

The housing or unit 10 may further include a temperature indicator 28 comprising a visual temperature indicator, an audible temperature indicator, a feel/touch indicator, or a combination thereof. For example, the visual temperature indicator may include one or more light emitting diodes (LED), a liquid crystal display (LCD), or a combination thereof. An exemplary embodiment of this type of visual indicator is manufactured by SANYO, located in Chatsworth, Calif., and may be identified by model number DM2023. However, other types of LEDs or LCDs may be used in the hand-held instrument. The visual temperature indicator may provide a textual indicator of the temperature, a color coded indicator of the temperature, or a combination thereof. The visual temperature indicator also may flash upon reaching or passing a specific temperature, such as an upper limit, a lower limit, a target temperature, or a combination thereof. By further example, the audible temperature indicator may include a simulated voice indicating the temperature, an audible alarm at specific temperatures (e.g., intervals of 1, 5, 10, or 20 degrees Fahrenheit), or a combination thereof. Similar to the visual temperature indicator, the audible temperature indictor may engage (e.g., beep) upon reaching or passing a specific temperature, such as an upper limit, a lower limit, a target temperature, or a combination thereof. Finally, the touch/feel indicator may include a vibration mechanism, which can function as an alarm similar to the audible or visual indicators upon reaching or passing a specific temperature.

The housing or unit 10 may further include a communications switch 30, a communications port 32, and a recall switch 34. Communications port 32 enables the hand-held instrument 10 to communicate with external devices to transmit or receive various data. For example, a communications cable may be plugged into the port 32 and a remote unit, such as a computer, a control unit, or power supply. Recall switch 34 enables the user to quickly access a data point contained within in a data set. For example, the user might want to recall the highest temperature measured by the hand-held instrument 10. Again, the illustrated hand-held instrument 10 is a single hand-held unit or all-in-one unit, which may be defined as a single structure having all of the respective elements contained within, attached to, or integrated within the single structure. For example, in one embodiment, the hand-held instrument 10 of FIG. 1 may integrate the thermocouple element 17, electronics 22, power source 24, trigger 16, and temperature indicator 28 into the single hand-held unit or housing. This integration greatly facilitates the use of the hand-held instrument 10 in determining an object's surface temperature and enables a one-handed or hands-free operation of the hand-held instrument 10. Additionally, in other embodiments, the hand held instrument may integrate other elements, for example, communications switch 30, a communications port 32, and a recall switch 34, into the single hand-held unit or housing 12.

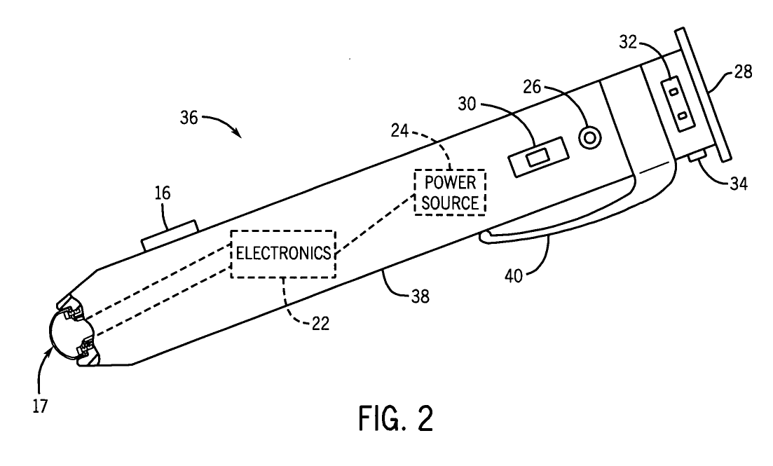

FIG. 2 illustrates a second embodiment of a hand-held instrument 36. As with the first embodiment, all of the elements may be contained within a single hand-held chassis or housing 38, which facilitates a one-handed or hands-free operation of the hand-held instrument 36. Housing 38 is stylus or pen-shaped and further includes a user mount 40 configured to enable the hand-held instrument 36 to be mounted to a user, clothing, or a combination thereof. In the present embodiment, user mount 40 is a pocket clip enabling a user to secure the hand-held instrument to a shirt pocket. However, user mount 40 is not limited to a pocket clip and the hand-held instrument may incorporate additional items or features for securing the instrument to a user. For example, the hand-held instrument may include features that enable the hand-held instrument to be removably fixed to a glove. By further example, the user mount 40 may include a hook and loop fastener (e.g., Velcro), a strap, an alligator clip, a button, a belt clip, or a combination thereof. Again, all of the elements, thermocouple element 17, electronics 22, power source 24, trigger 16, and temperature indicator 28 are disposed in a single chassis or housing. The housing may also include communications port 32, power receptacle 26, communications switch 30, and recall switch 34. Additionally, as discussed above, the hand-held instrument is not limited to the embodiment shown in FIG. 2.

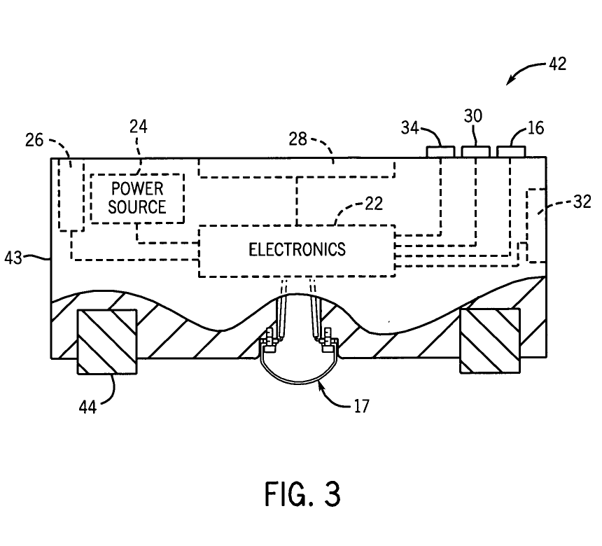

FIG. 3 illustrates a third embodiment of a hand-held instrument 42. As with the first two embodiments, some or all of the elements may be contained within a single hand-held chassis or housing 43, thereby facilitating one-handed or hands-free operation of the instrument. Housing 43 is disc-shaped and further includes a surface mount 44. In the present embodiment, the surface mount includes a magnetic element for coupling the unit 42 to a magnetically permeable object. However, surface mount 44 is not limited to a magnetic element and hand-held instrument 42 may incorporate additional items or features for removably securing the hand-held instrument to an object. For example, hand-held instrument 42 may include a mechanical connector that enables the user to clamp the hand-held instrument 42 to an object. Additionally, the hand-held instrument is not limited to only measuring surface temperature of metallic objects and may be used to measure the surface temperature of any type of object. Once again, thermocouple element 17, electronics 22, power source 24, temperature indicator 28, and trigger 16 are disposed in a single chassis or housing for one of the contemplated embodiments. Additionally, other embodiments may include communications port 32, power receptacle 26, communications switch 30, and recall switch 34 also disposed in the single chassis. Additionally, as discussed above, the hand-held instrument is not limited to the embodiment shown in FIG. 3.

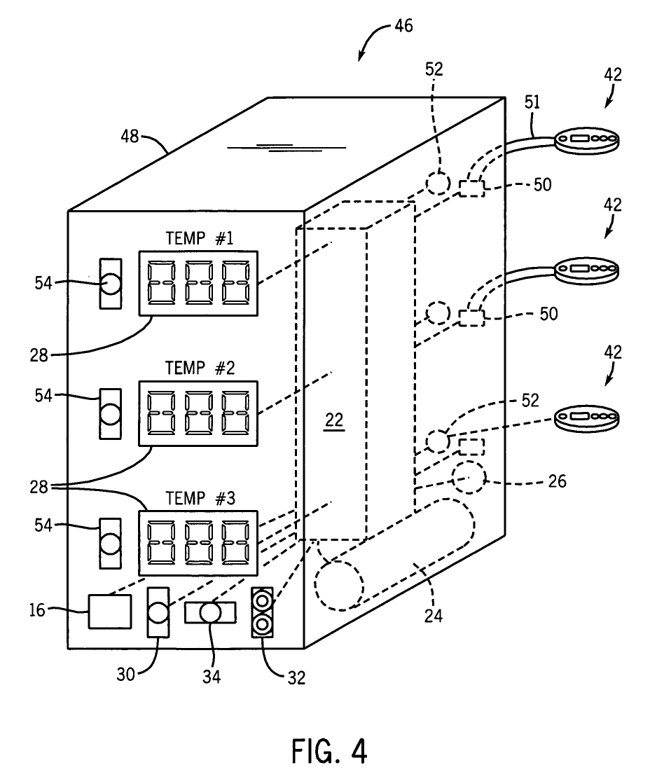

FIG. 4 illustrates a remote unit 46 that may be used in conjunction with any of the contemplated embodiments of the hand-held instruments, e.g., 10, 36, and 42. The remote unit 46 comprises a control box 48 that may include the elements discussed in reference to the hand-held instrument itself. These elements include electronics 22, power source 24, temperature indicator 28, communications port 32, trigger 16, power receptacle 26, communications switch 30, and recall switch 34. In addition, remote unit 46 includes communications circuitry for communicating with hand-held instrument 10, 36, 42 via an interface port 50. The interface port 50 may include a conductor receptacle or plug enabling the remote unit 46 to connect to the hand-held instrument 42 via an electrical conductor 51. Additionally, the communications circuitry may include a wireless interface 52 (e.g., wireless transceiver) enabling the unit to connect to the hand-held instrument 42 via a wireless transmission. Finally, remote unit 46 may include a thermocouple selector 54 enabling the remote unit 46 to interface with a number of different types of thermocouples.

As illustrated, the remote unit 46 enables the collection and display of multiple temperature measurements for an object via the multiple temperature indicators 28. Thus, multiple hand-held instruments (e.g., 42) may be distributed around the object to provide a more accurate representation of the spatial surface temperature. This can be useful in quickly communicating a temperature profile of the object. Furthermore, it enables remote monitoring (i.e., supervisor or control system) of the surface temperature. The control system may compute an average temperature, an uppermost temperature, a lowermost temperature, or a combination thereof based on the multiple temperature readings from the hand-held instruments 42. As a result, the system can provide real-time control of a closed loop operation. Alternatively, the control system can display a recommended action to the operator or supervisor based on the multiple temperature readings.

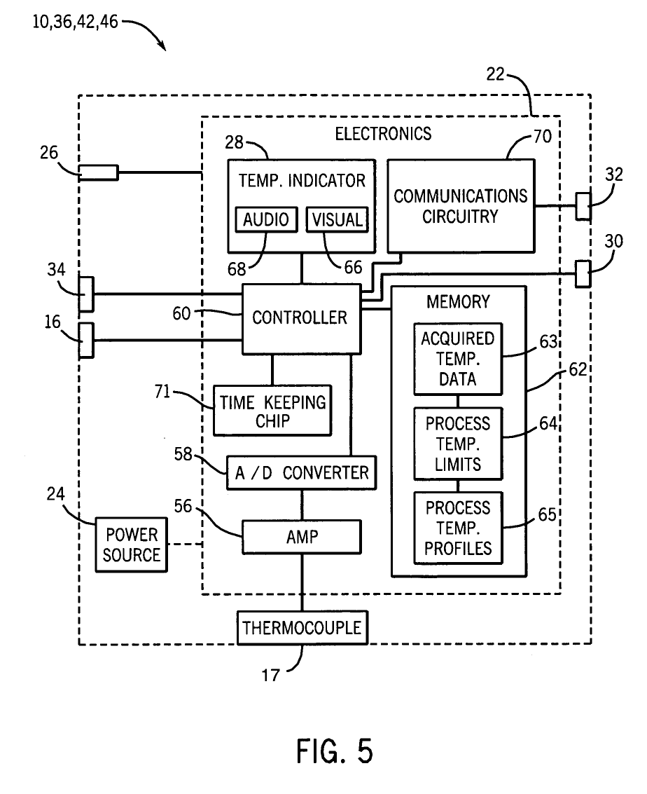

FIG. 5 is a block diagram functionally illustrating the elements of the hand-held instrument and the respective interface of these elements. As discussed, thermocouple 17 is coupled to electronics 22 and power source 24. Electronics 22 includes a signal amplifier 56, an analog-to-digital converter 58, a controller 60, a memory 62, and temperature indicator 28. Additionally, certain embodiments may also include communications circuitry 70. Controller 60 may be described as the hub or master node where all of the individual elements interface with one another. An exemplary embodiment of this type of controller is manufactured by Microchip, located in Chandler, Ariz., and may be identified by model number 16F877. However, other types of controllers may be used in the hand-held instrument. Each of the other respective elements will be described in further detail below.

Memory 62 is coupled to controller 60 and is configured to store acquired temperature data 63, temperature limits 64, temperature profiles 65, and/or other related data. An exemplary embodiment of this type of memory is manufactured by Atmel, located in San Jose, Calif., and may be identified by model number AT24C1024. However, other types of memory may be used in the hand-held instrument. Acquired temperature data 63 includes the data obtained by the hand-held instrument and may be indicative of the object's temperature. The controller 60 may be configured with an internal clock or coupled to a time keeping chip 71 to time stamp acquired temperature data 63 to facilitate data correlation with external events. An exemplary embodiment of this type of time keeping chip is manufactured by Maxim Integrated Products, located in Sunnyvale, Calif., and may be identified by model number DS1302. However, other types of internal clocks may be used in the hand-held instrument. Temperature limits 64 may include an upper temperature limit, a lower temperature limit, and/or one or more target temperatures specified by the user for any given operation or application. Temperature profiles 65 may include a target temperature-versus-time profile further including a plurality of target temperature corresponding to target times. Finally, other related data may include a job number, inspector number, control signal trip level, or any other information that might relate to the temperature measurement or system.

Signal amplifier 56 is coupled to controller 60. The signal amplifier 56 may include a monolithic thermocouple amplifier with cold junction compensation. An exemplary embodiment of this particular amplifier is manufactured by Analog Devices, located in Norwood, Mass., and may be identified by part number AD594/AD595. However, other types of amplifiers may be used in the hand-held instrument.

Temperature indicator 28 is coupled to controller 60 and may include a visual temperature indicator 66, such as a LED or LCD, and/or an audible temperature indicator 68. These indicators provide real-time temperature measurements to a user, technician, or supervisor. Real-time may be defined as no time lag or a relatively small amount of time lag, e.g., less than 2, 1, 0.5, or 0.1 second, with the amount of time lag being determined by the required accuracy of the hand-held instrument 10, 36, 42. Also, other examples of response times are less than 10, 9, 8, 7, 6, 5, 4, or 3 seconds. However, it should be noted that a preferred embodiments of the present invention enables a quick and accurate response in less than 2 seconds, yet an increase in this response time is also within the scope of the present invention.

The hand-held instrument may also be configured to obtain a plurality of temperature measurements within a reset time that is partially dependent on the thermal stability of the surface to be measured. For example, one of the contemplated embodiments enables the user to obtain a successive measurement in a period of no longer than 15 seconds once a stable surface temperature is detected. A stable measurement may be defined as a measurement that has not changed +/−2 degrees Fahrenheit over a 2 second time interval, or a measurement that is has reached a maximum temperature and is now starting to decrease. However, embodiments of the present invention are not functionally limited to the specific stability criteria disclosed and may be programmed with different stability criteria. Additionally, a successive measurement could be taken at the user's discretion by activating the trigger before a stable measurement is acquired.

As discussed, the present embodiment incorporates a 15 second time lag between successive measurements. The majority of the 15 second lag time, possibly 12 seconds or more of the 15 seconds, is due to the device displaying the most recent measurement for a pre-determined time (e.g., 12 seconds) to enable the user to observe and/or record the measurement. It is important to note that this 15 second lag time is not driven by the temperature response of the hand-held instrument but instead by a desired functionality. Moreover, the hand-held instrument may be configured to enable the user to view the temperature measurement in an uninterrupted manner by continually displaying the measurements as the instrument acquires them or as the user request them via engaging trigger 16. In this type embodiment, the measurements may be updated and displayed in less than 2 seconds or any of the time increments discussed above.

Finally, controller 60 may be coupled to communication circuitry 70 that enables the hand-held instrument to interface with external devices via a communications port 32. This communication port 32 may include wireless circuitry or a wired port to access controller 60 and memory 62. The wireless circuitry may include a wireless radiofrequency (RF) transceiver, an infrared transceiver, or other suitable wireless communications circuitry. The communications circuitry 70 is configured to facilitate exchange of temperature data, operating parameters, control signals, and other information between the hand-held instrument and a remote unit. Thus, the communications circuitry 70 enables uploading and/or downloading of various data with the memory 62.

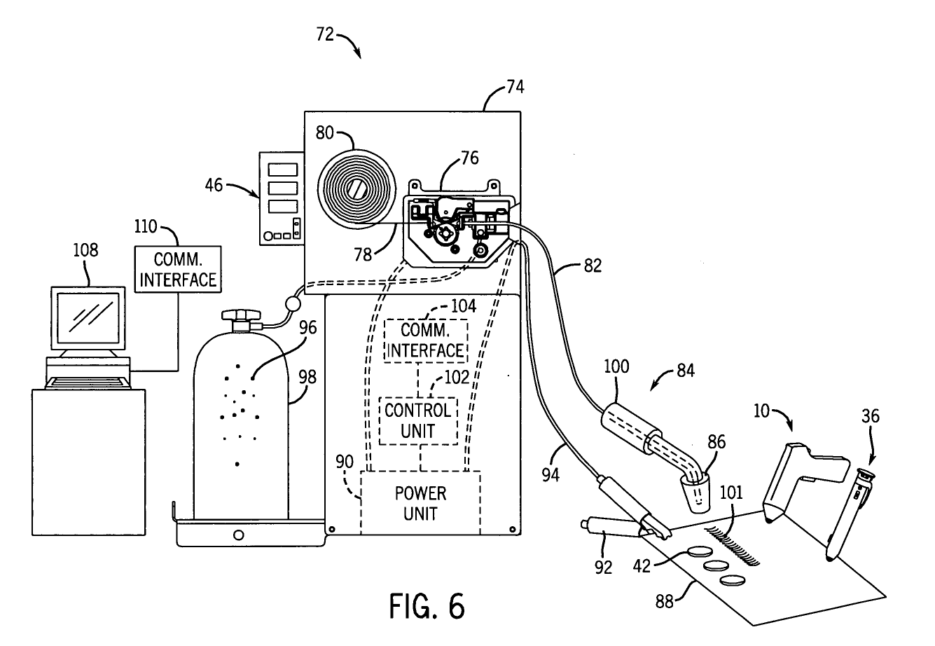

Referring generally to FIG. 6, this figure depicts an exemplary metal inert gas (MIG) arc welding system 72 and illustrates one of the many possible applications for the hand-held instrument. Welding system 72 includes a welding chassis 74 with a wire feeding assembly 76 disposed therein. The wire feeding assembly 76 is configured to automatically feed an electrode wire 78 from a wire spool 80 into and through a welding cable 82 leading to a welding gun 84. In the illustrated embodiment, the electrode wire 78 has a generally tubular shape and a metallic composition. A flux also may be disposed within the tubular metal electrode wire 78. Eventually, the electrode wire 78 passes through and protrudes from a welding contact tip and nozzle assembly 86, where the peripheral end or tip of the electrode wire melts with an object or work piece 88 as an arc forms during a welding operation. In certain embodiments, the wire feeder 76 may be separate from the welding chassis 74, e.g., a stand-alone wire feeder.

A welding circuit is set up as follows. A power unit 90 is connected to the wire feeder 76, which is further connected to conductors disposed inside the welding cable 82. These conductors are adapted for transmitting current or power from the power unit 90 of the welding system 72 to the welding gun 84. Welding gun 84, in turn, transmits the current or power to the contact tip in the assembly 86. The work piece 88 is electrically coupled to one terminal of the power unit 90 by a ground clamp 92 and a ground cable 94. Thus, an electrical circuit between the work piece 88 and the power unit 90 is completed when the electrode wire 78 of the welding gun is placed in proximity to, or in contact with, the work piece 88, and the welding gun 84 is engaged to produce an arc between the wire 78 and the work piece 88. The heat produced by the electric current flowing into the work piece 88 through the arc causes the work piece to melt in the vicinity of the arc, also melting the electrode wire 78. Thus, the arc generally melts a portion of the work piece 88 and a tip portion of the electrode wire 78, thereby creating a weld with materials from both the work piece and the welding wire.

In the illustrated embodiment, inert shield gas 96 stored in a gas cylinder 98 may be used to shield the molten weld puddle from impurities. For example, the gas cylinder 98 feeds gas 96 to the wire feeder 76. The gas is fed, along with the electrode wire 78, through the welding cable 82 to the neck of the welding gun 100. The inert shield gas 96 generally prevents impurities from entering the weld puddle and degrading the integrity of the weld. However, other shielding techniques, such as a flux on the electrode wire 78, may be used in certain embodiments of the welding system 72.

As discussed above, the work piece 88 may be preheated to improve the quality of the weld joint 101 and to facilitate the welding operation in general. The illustrated embodiment enables the user to quickly and accurately determine, in real-time, the temperature of the work piece 88 by contacting the welding instrument, e.g., 10, 36, 42, to the work piece. Furthermore, the welding operation may be improved by using the weld instrument 10, 36, 42 as a feedback sensor in a closed loop system to control various welding parameters or other related parameters (e.g., indicator light, fan, motor, etc.) based on the work piece temperature. As illustrated in FIG. 6, a control unit 102 and communication interface 104 may be coupled to the power source 90, wire feed assembly 76, and inert gas 96 supply. The communication interface 104 may be configured to communicate directly with the hand-held instrument 10, 36, 42, or the interface 104 may be configured to communicate with the hand-held instrument via the remote unit 46. Control unit 102 may then adjust the weld parameter (e.g., power supplied to the work piece, electrode wire feed rate, gas flow rate, etc.) based on the work piece temperature. Furthermore, a work station 108 may be implemented in the closed loop system or may be used to remotely monitor the welding operation, for example by a weld supervisor. The work station 108 may be configured to interface with the hand-held instrument 10, 36, 42 and/or the remote unit 46 through a communication interface 110. Work station 108 may be a desktop computer, laptop computer, or even a smaller portable unit.

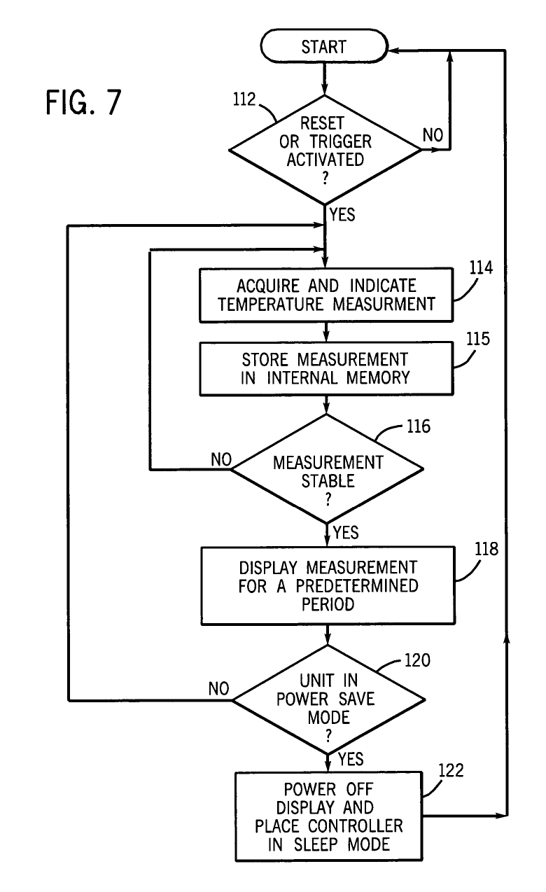

FIG. 7 is a flow chart illustrating one method of using an embodiment of the hand-held instruments 10, 36, 42. The process is initiated by the user activating the reset or trigger 16 located on the hand-held instrument (block 112). Before the trigger is activated, the held-instrument is either powered off or in a low load state in order to conserve power. Once activated, the hand-held instrument acquires and indicates a temperature measurement (block 114). The hand-held instrument will acquire the measurement in real-time (i.e., less than 2 seconds or shorter time interval) and may indicate the measurement via the temperature indicators discussed above (e.g., the visual indicator, the audible indicator, or a combination thereof). Additionally, the controller 60 may be configured with an internal memory, separate from memory 62, which can temporarily store the measurement (block 115) in order to determine when the measurement has reached a stable value.

Once the measurement has reached a stable value (block 116), the hand-held instruments displays the measurement for a predetermined period (block 118). The criteria for a stable measurement may be altered depending on the application, and generally will be determined by the measurement reaching a point where it has not changed +/−2 degrees Fahrenheit over a two second interval or has reached a maximum temperature. Also, the predetermined period for displaying the measurement can be adjusted and will depend on the application. In other words, the predetermined period is not functionally limiting and is determined by the amount of time the user prefers to display the measurement before proceeding. As discussed above, this time will typically be in the range of 15 seconds, but may be changed to a shorter or longer time interval depending on the application. Additionally, the hand-held instrument may be configured with a power save mode that conserves energy by placing the controller and other elements in a low load state. For example, the controller may be programmed to switch to a sleep mode that maintains certain minimal functionality without completely disabling the hand-held instrument. This enables the instrument to quickly switch back to normal operating mode when triggered, while at the same time conserving energy when the device is not in use. Thus, after the hand-held instrument displays the measurement (block 118), the controller then determines if it is in power save mode (block 120), and if it is, the controller turns off power to the temperature indicator and places itself in sleep mode (block 122) until the reset or trigger is further activated (block 112). It should also be noted, that the device can be taken out of power save mode enabling the hand-held instrument to provide a continuous temperature measurement. This feature may be useful when there is a continuous power source, for example when the power receptacle 26 is being used to interface a remote power source.

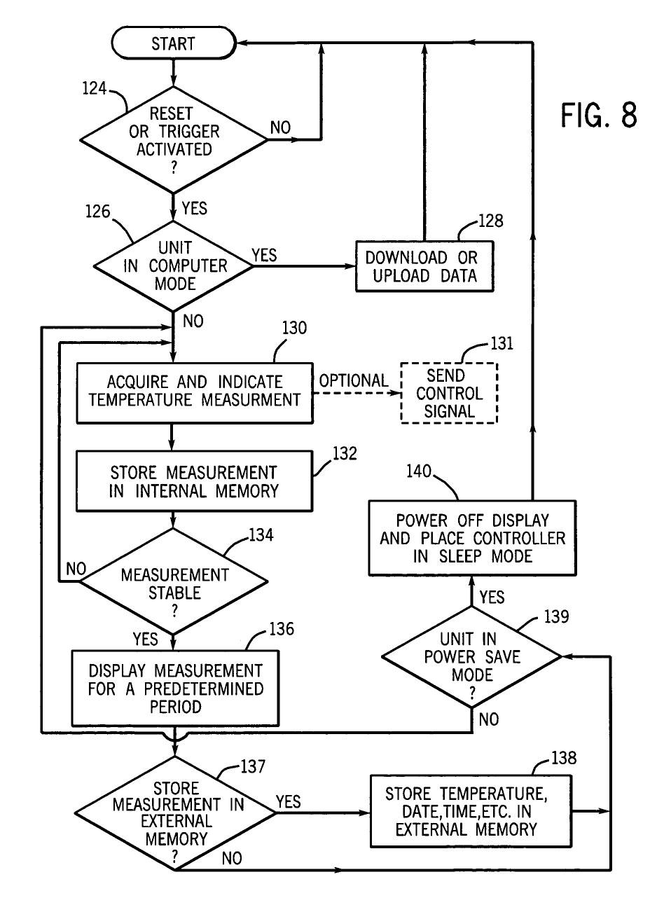

FIG. 8 is a flow chart illustrating a second method of using an embodiment of the hand-held instruments 10, 36, 42. As with the first method, the instrument is in a power save mode until the user initiates the process by activating the trigger 16 of the hand-held instrument (block 124). However, unlike the first method, in this method the hand-held instrument is configured with a computer mode (block 126). The computer mode enables the user to upload or download data, as discussed above, to or from memory 62 of the hand-held instrument (block 128). The computer mode may be enabled or disabled by the communications switch 30. In addition to temperature information, the data may include a job number, inspector number, control signal trip level, a target temperature, a maximum temperature, a minimum temperature, a temperature versus time profile, a combination thereof, etc.

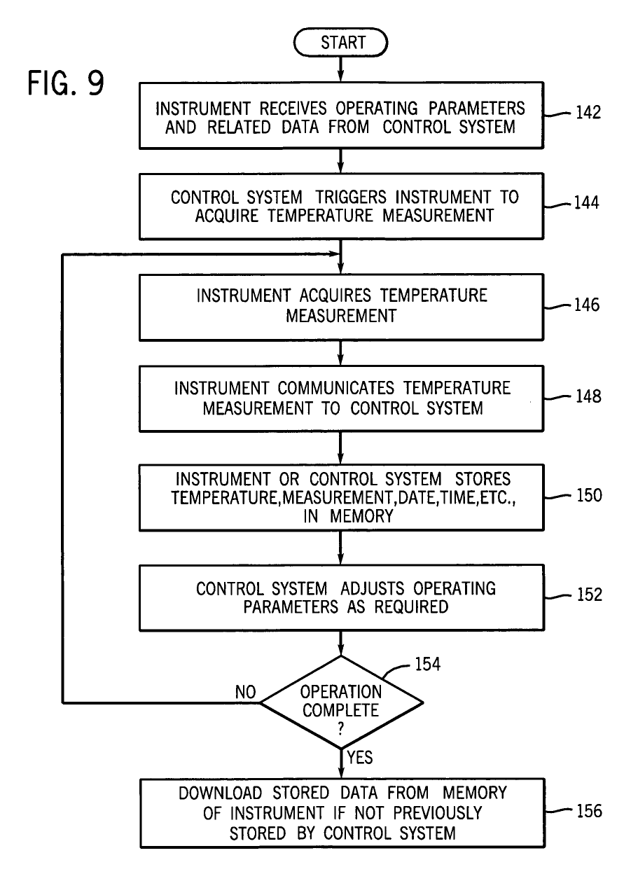

Once the download/upload is complete, the hand-held instrument may be switched out of computer mode and may begin to acquire/indicate a temperature measurement (block 130). As before, the hand-held instrument will acquire the measurement in real-time (i.e., less than 2 seconds or a shorter time interval) and may indicate the measurement via any of the temperature indicators discussed above (e.g., the visual indicator, the audible indicator, or a combination thereof). Additionally, the controller 60 may be configured with an internal memory that can temporarily store the measurement (block 132) in order to determine when the measurement has reached a stable value. The hand-held instrument waits for the measurement to stabilize (block 134) and then displays the measurement for a predetermined period (block 136). The criteria for a stable measurement may be altered depending on the application, and generally will be determined by the measurement reaching a point where it has not changed +/−2 degrees Fahrenheit over a two second interval or has reached a maximum temperature. Also, the predetermined period for displaying the measurement can be adjusted and will depend on the application. As discussed above, this time will typically be in the range of 15 seconds, but may be changed to a shorter or longer time interval depending on the application. Optionally, as will be described in more detail with reference to FIG. 9, the hand-held instrument may then send the temperature measurement or signal to an external device that may use the information for a closed loop control process (block 131). This data may be sent via communication circuitry 70 and communication port 32 contained within the single chassis of the hand-held instrument.

Once the measurement has stabilized and displayed, the hand-held instrument will inquire if the user would like to store the measurement in memory 62, that is, memory external to the controller but internal to the hand-held instrument (block 137). If the user decides the data should be stored, then the hand-held instrument may time stamp the data, via the time keeping chip 71, and store the temperature measurement in memory 62 (block 138). As with the first method, the hand-held instrument may be configured with a power save mode that conserves energy by placing the controller and other elements in a low load state. Thus, after the instrument has determined whether or not to store the data (block 137, 138), the controller then determines if it is in power save mode (block 139). If it is in power save mode, the controller turns off power to the temperature indicator and places itself in sleep mode (block 140) until the trigger is further activated (block 124). Also, as before, the device can be taken out of power save mode enabling the hand-held instrument to continually acquire, indicate, and store the temperature measurement. For either of these methods, the hand-held instrument may be configured to enable the user to manually start or stop data acquisition via activating trigger 16, and as discussed above, the trigger could be used to implement other functions.

FIG. 9 is a flow chart illustrating a third method of using an embodiment of the hand-held instrument in a closed loop system. The process is initiated by communicating the desired operating parameters and related data to the control system (block 142). Exemplary embodiments of the control system may include a remote work station 108, a control unit 102 coupled to the welding system 74, the hand-held instrument 10, 36, 42, or the operator. The operating parameters and related data may include process temperature limits 64 or process temperature profiles 65 or other related process information. Next, the control system triggers the hand-held instrument to acquire a temperature measurement (block 144) resulting in the hand-held instrument 10, 36, 42 acquiring the temperature measurement (block 146). The hand-held instrument will acquire the measurement in real-time (i.e., less than 2 seconds or shorter time interval) and may communicate the measurement via the temperature indicators discussed above (e.g., the visual indicator, the audible indicator, or a combination thereof) (block 148). Additionally, the hand-held instrument may communication the measurement via the communication circuitry 70 and communication port 32. As discussed above, communication circuitry 70 and communication port 32 may include wireless circuitry or a wired port. The wireless circuitry may include a wireless radiofrequency (RF) transceiver, an infrared transceiver, or other suitable wireless communications circuitry. The communications circuitry 70 is configured to facilitate exchange of temperature data, operating parameters, control signals, and other information between the hand-held instrument and the control system or remote unit.

Once the communication of the data has taken place, the hand-held instrument or control system then stores the data (block 150) and the control system may then adjust the operating parameters as required (block 152). The process may then proceed in this closed loop manner (block 154) until the operation is complete. Once the operation is complete, the stored data may be downloaded from the hand-held instrument (block 156) if not previously stored by the control system or external device.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A hand-held instrument for measuring temperature, comprising:
a temperature transducer configured to measure a surface temperature up to at least 200 degrees Fahrenheit;
electronics coupled to the temperature transducer;
a temperature indicator coupled to the electronics; and
a power source coupled to the electronics, wherein the temperature transducer, the electronics, the temperature indicator, and the power source are all disposed in a single chassis of the hand-held instrument.

2. The hand-held instrument of claim 1, wherein the temperature transducer is exposed and is configured to be placed in direct contact with the surface.

3. The hand-held instrument of claim 1, wherein the temperature transducer and the electronics are configured to measure the surface temperature in a response time of less than 5 seconds.

4. The hand-held instrument of claim 1, wherein the temperature transducer and the electronics are configured to obtain a plurality of temperature measurements with a reset time of at less than 15 seconds prior to a successive measurement.

5. The hand-held instrument of claim 1, wherein the single chassis comprises a gun-shaped body.

6. The hand-held instrument of claim 1, wherein the single chassis comprises a stylus or pen-shaped body.

7. The hand-held instrument of claim 1, wherein the single chassis comprises a disc-shaped body.

8. The hand-held instrument of claim 1, wherein the single hand-held unit comprises a user mount, or a surface mount, or a combination thereof.

9. The hand-held instrument of claim 1, wherein the temperature transducer comprises a thermocouple.

10. The hand-held instrument of claim 9, wherein the thermocouple comprises a type-J thermocouple or a type-K thermocouple.

11. The hand-held instrument of claim 1, wherein the temperature transducer is configured to measure the surface temperature up to at least 400 degrees Fahrenheit.

12. The hand-held instrument of claim 1, wherein the temperature transducer is configured to measure the surface temperature up to at least 600 degrees Fahrenheit.

13. The hand-held instrument of claim 1, wherein the temperature indicator comprises an audible temperature indicator, a visual temperature indicator, a vibration indicator, or a combination thereof.

14. The hand-held instrument of claim 1, wherein the electronics comprise an internal clock configured to time stamp temperature data obtained from the temperature transducer.

15. The hand-held instrument of claim 1, wherein the electronics comprise memory configured to store data including data representative of the surface temperature.

16. The hand-held instrument of claim 1, wherein the electronics comprise communications circuitry configured to upload data, download data, or a combination thereof relative to an external device.

17. The hand-held instrument of claim 16, wherein the communications circuitry comprises wireless communications circuitry.

18. The hand-held instrument of claim 16, comprising a communications switch configured to start or stop data transmission between the hand-held instrument and the external device.

19. The hand-held instrument of claim 1, comprising a trigger configured to start or stop data acquisition via the temperature transducer and the electronics.

20. The hand-held instrument of claim 1, comprising a recall switch configured to access a data point in a data set acquired by the temperature transducer and the electronics.

21. The hand-held instrument of claim 1, wherein the electronics comprise a controller, an analog-to-digital converter, and a signal amplifier.

22. The hand-held instrument of claim 21, wherein the electronics further comprise communications circuitry, a time keeping chip, and memory.

23. The hand-held instrument of claim 1, wherein the electronics comprises a power save mode.

24. A hand-held instrument for measuring temperature, comprising:
an exposed thermocouple element configured to be placed in direct contact with a surface to be measured;
electronics coupled to the exposed thermocouple element; and
a power source configured to power the hand-held instrument, wherein the exposed thermocouple element, the electronics, and the power source are integrated into a single housing of the hand-held instrument.

25. The hand-held instrument of claim 24, wherein the exposed thermocouple element is configured to measure data indicative of temperature up to at least 200 degrees Fahrenheit.

26. The hand-held instrument of claim 24, wherein the exposed thermocouple element, the electronics, and a temperature indicator are configured to indicate the temperature in a response time of less than 5 seconds.

27. The hand-held instrument of claim 24, wherein the exposed thermocouple element, the electronics, and a temperature indicator are configured to indicate the temperature in a response time of less than 2 seconds.

28. The hand-held instrument of claim 24, wherein the electronics comprises communications circuitry configured to exchange data between the hand-held instrument and a remote device.

29. The hand-held instrument of claim 28, wherein the communications circuitry comprises wireless communications circuitry.

30. The hand-held instrument of claim 24, wherein the electronics comprises a memory configured to store temperature data.

31. The hand-held instrument of claim 30, wherein the temperature data comprises a target temperature, a maximum temperature, a minimum temperature, a temperature versus time profile, or a combination thereof.

32. A hand-held instrument for measuring temperature, comprising:
a temperature sensor configured to provide data indicative of temperature in real-time; and
a wireless communication circuit configured to communication the data wirelessly to an external destination.

33. The hand-held instrument of claim 32, comprising a temperature indicator configured to output an indication of the temperature in real-time.

34. A hand-held instrument for measuring temperature, comprising:
a temperature sensor;
a temperature indicator coupled to the temperature sensor; and
communication circuitry configured to upload data, download data, or a combination thereof, wherein the temperature sensor, the temperature indicator, and the communication circuitry are all disposed in a single chassis of the hand-held instrument.

35. The hand-held instrument of claim 34, wherein the data comprises an upper temperature limit, a lower temperature limit, one or more temperature targets, and/or a combination thereof.

36. The hand-held instrument of claim 34, wherein the data comprises a target temperature-versus-time profile having a plurality of temperatures and corresponding times.
